(19) United States
(12) Patent Application Publication
(10) Pub. No.: US 2020/0341507 A1
(43) Pub. Date: Oct. 29, 2020

(54) ELECTRONIC DEVICE HAVING A POINTING STICK

(71) Applicant: LENOVO (SINGAPORE) PTE. LTD., SINGAPORE (SG)

(72) Inventor: Fumio Tamura, Kanagawa (JP)

(21) Appl. No.: 16/855,422

(22) Filed: Apr. 22, 2020

(30) Foreign Application Priority Data
Apr. 24, 2019 (JP) 2019-83299
Nov. 26, 2019 (JP) 2019-213212

(51) Int. Cl. G06F 1/16; G06F 3/0338

(52) U.S. Cl. CPC G06F 1/169; G06F 3/0338

(57) ABSTRACT

An electronic device having a pointing stick is disclosed. The pointing stick includes a cap mounted on a stick. The cap has a first surface and a second surface opposite to the first surface. A bottomed hole recessed towards the second surface is formed in the first surface. The bottomed hole is composed of a bottom wall located between the first surface and the second surface, a side wall connecting the bottom wall and the first surface, and a contact portion protruding from the bottom wall toward the first surface. The contact portion is provided in a region away from an outer edge of the bottom wall.

### PRIORITY CLAIM

The present application claims benefit of priority under 35 U.S.C. §§ 120, 365 to the previously filed Japanese Patent Application No. JP2019-83299 with a priority date of Apr. 24, 2019, and Japanese Patent Application No. JP2019-213212 with a priority date of Nov. 26, 2019, which are incorporated by reference herein.

### TECHNICAL FIELD

The present invention relates to electronic devices in general, and in particular to an electronic device having a pointing stick.

### BACKGROUND

An electronic device, such as a laptop personal computer, may come with a pointing device for operating a pointer displayed on a display. In addition to a computer mouse, a pointing stick can be used as a pointing device. TrackPoint® is a typical example of a pointing stick.

A pointing stick includes a flat plate-like sensor module that detects pressure, a pole-like stick fixed to the sensor module, and a cap mounted on a distal end part of the pointing stick. The cap is typically made of soft material, such as rubber, in order to reduce potential damage to the surface of a display that may come in contact with the cap when the display is closed and/or to allow a user to comfortably touch the cap during use.

As electronic devices have been becoming thinner, the length of the corresponding pointing stick also becomes shorter. When a force with which a user's finger-tip presses the cap is decomposed into a (substantially horizontal direction parallel to the sensor module and a (substantially vertical) direction perpendicular to the sensor module, the shorter the length of the pointing stick becomes, the higher a ratio of a component in the perpendicular direction tends to be. If the ratio of the component in the perpendicular direction becomes higher, the cap is elastically deformed, so that a mouse pointer may stray in a direction not intended by the user.

Consequently, it would be desirable to provide an improved pointing stick with which a mouse pointer is easily operated as intended by a user even though the length of the pointing stick is shorter.

### SUMMARY

In accordance with an embodiment of the present disclosure, a pointing stick includes a cap mounted on a stick. The cap has a first surface and a second surface opposite to the first surface. A bottomed hole recessed towards the second surface is formed in the first surface. The bottomed hole is composed of a bottom wall located between the first surface and the second surface, a side wall connecting the bottom wall and the first surface, and a contact portion protruding from the bottom wall toward the first surface. The contact portion is provided in a region away from an outer edge of the bottom wall.

Alternatively, a pointing stick includes a cap, a sensor module that detects pressure, and a pole-like stick fixed to the sensor module. In the cap, a bottomed hole into which a distal end part having a part of a side surface and a distal end surface of the stick is inserted, is formed. The bottomed hole is composed of a bottom wall facing the distal end surface, and a side wall facing a part of the side surface. In a state in which the cap is mounted on the stick, a contact portion that transmits a force inputted from a user to press the stick is provided in a region away from an outer edge of the bottom wall.

All features and advantages of the present disclosure will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a perspective view of an electronic device equipped with a pointing stick according to one embodiment;

FIG. 2 is a perspective view illustrating a keyboard with an upper cover removed;

FIG. 3 is a cross-sectional view illustrating one example of a pointing stick according to a first embodiment;

FIG. 4 is a top view of the pointing stick from FIG. 3 without a cap;

FIG. 5 is a bottom view of the cap from FIG. 3, according to a first embodiment;

FIG. 6 is a bottom view of the cap from FIG. 3, according to a second embodiment;

FIG. 7 is a cross-sectional view of the cap from FIG. 3;

FIG. 8 is a bottom view of a conventional cap, illustrated for comparison with the cap from FIG. 5;

FIG. 9 is a cross-sectional view illustrating components in the perpendicular direction acting on the stick when a conventional cap is used;

FIG. 10 is a cross-sectional view illustrating one example of the pointing stick according to a second embodiment;

FIG. 11 is a cross-sectional view illustrating a stress distribution when the cap from FIG. 10 is used; and

FIG. 12 is a cross-sectional view illustrating a stress distribution when a conventional cap is used.

### DETAILED DESCRIPTION

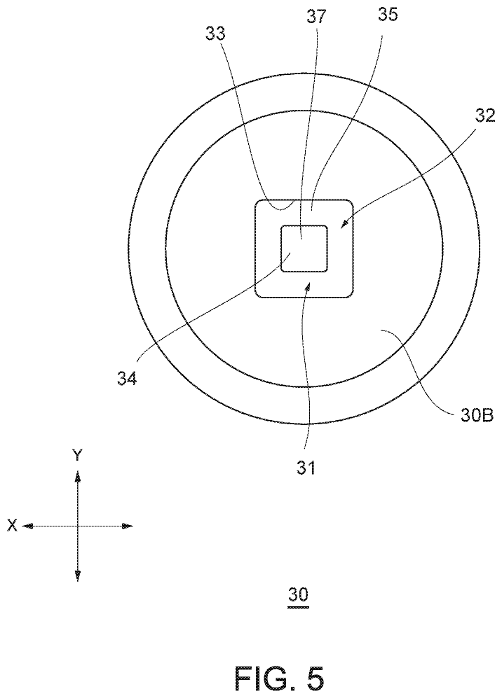

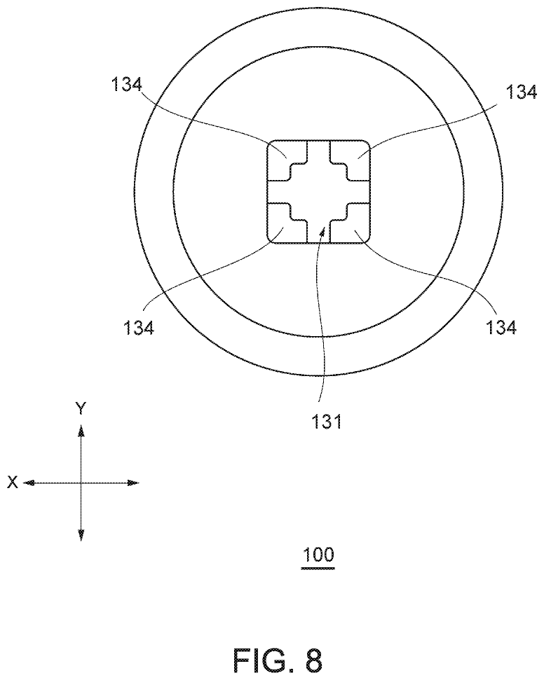

Preferred embodiments of the present invention will be described with reference to the drawings. Incidentally, in the respective drawings, constitutional elements to which the same symbols are assigned have the same or similar configurations. One of features of a cap 30 and a pointing stick 9 is that a contact portion 34 is provided in a region (a central region 37, for example) away from an outer edge 35 of a bottom wall 32 of the cap 30, as illustrated in FIGS. 5-7. FIG. 8 is a bottom view illustrating one example of a general cap (track point cap) 100. As illustrated in FIG. 8, conventional contact portions 134 were provided in four corners of a bottomed hole 131 having a substantially square cross-section.

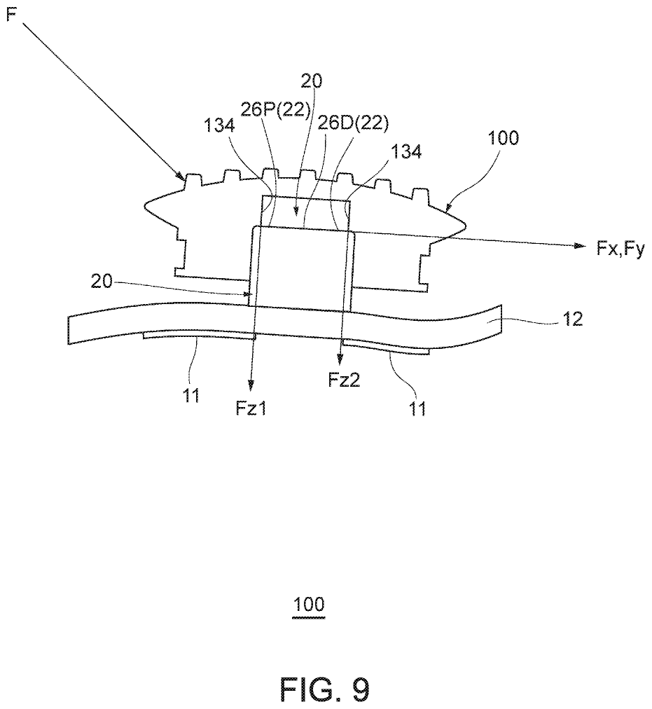

FIG. 9 is a cross-sectional view illustrating components in the perpendicular direction acting on the stick 20 when the cap 100 from FIG. 8 is used. As illustrated in FIG. 9, in a conventional configuration in which the contact portions 134 press outer peripheries 26P and 26D of a distal end surface 22 of the stick 20, when the cap 100 is elastically deformed, pressing force F might become non-uniform and cause a phenomenon to strongly press the outer periphery 26P on a side near the user's finger-tip and weakly press the outer periphery 26D on a side far from the user's finger-tip (Fz1>Fz2).

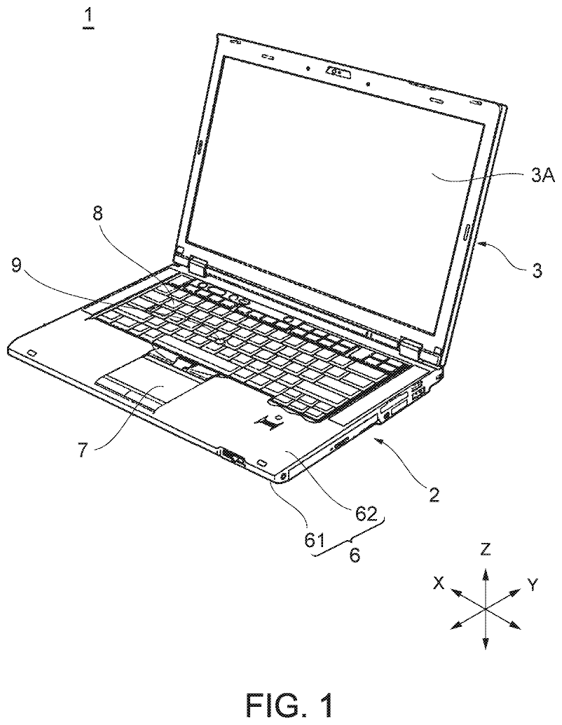

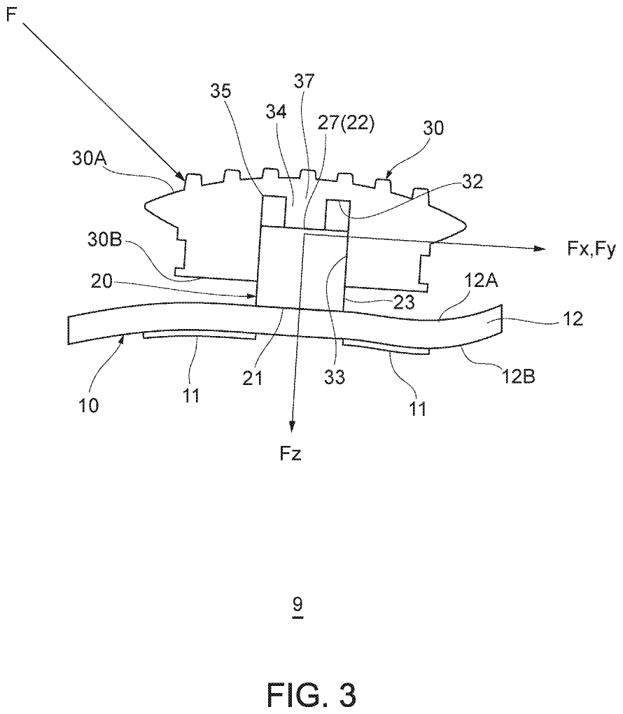

As a result, although the user wants to move the mouse pointer in a direction away from his/her finger-tip, the mouse pointer sometimes did not move as intended by the user, for example, it strayed in a direction coming closer to his/her finger-tip, or its speed became slow. According to the cap 30 of each embodiment, such straying can be prevented since the contact portion 34 presses the central region 27 of the distal end surface 22 of the stick 20 as illustrated in FIG. 3. Each configuration will be described in detail below with reference to FIG. 1 to FIG. 12.

FIG. 1 is a perspective view an electronic device 1 equipped with the pointing stick 9 according to one embodiment. As shown, a laptop personal computer is disclosed as one example of the electronic device 1. It is to be noted that the electronic device 1 may be various computers such as a desktop personal computer, tablet terminal, smart phone, mobile-phone unit, game console, and digital signage, not limited to the laptop personal computer.

As illustrated in FIG. 1, the electronic device 1 includes a personal computer main body 2, and a display 3 connected to the personal computer main body 2 by a hinge 4. The display 3 has a display surface 3A that displays an image. The personal computer main body 2 includes a chassis 6 formed in a flat box shape. A chipset, a battery pack, etc. (not illustrated) are housed in the chassis 6.

A touch-pad 7, a keyboard 8, and the pointing stick 9 etc., for inputting a user's operation are provided in a top surface of the chassis 6. The chipset displays information on the display 3 based on the inputted operation. The battery pack supplies power to the display 3 and the chipset etc. The chassis 6 includes a lower cover 61 that constitutes a bottom surface of the chassis 6 and an upper cover 62 that constitutes the top surface of the chassis 6.

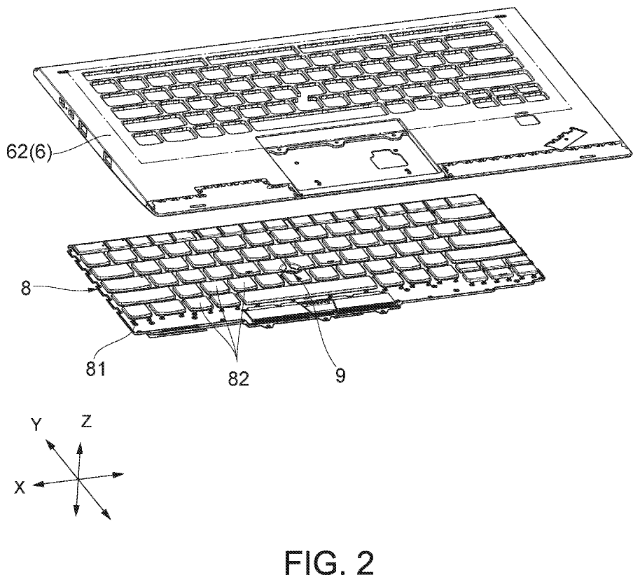

FIG. 2 is a perspective view illustrating the keyboard 8 and the pointing stick 9 with the upper cover 62 removed. As illustrated in FIG. 2, openings for exposing the touch-pad 7, the keyboard 8, and the pointing stick 9 etc. are formed in the upper cover 62. The keyboard 8 includes a flat plate-like keyboard substrate 81 on which a set of electrical contacts is arranged, and a set of keys 82 mounted on the electrical contacts of the keyboard substrate 81.

In the illustrated example, the pointing stick 9 is disposed in the central part of the keyboard 8, more specifically, in such a manner to be surrounded by three keys 82, “G,” “H,” and “B.” The pointing stick 9 detects inputs in the X-axis direction along a right and left direction and in the Y-axis direction along a front and rear direction, viewed from a user who provides input with respect to the keyboard 8 based on the arrangement of the keys 82. When a surface of the keyboard substrate 81 on which surface the electrical contacts are arranged is made a top surface and a surface opposite to the top surface is made a bottom surface, the Z-axis direction is a top and bottom direction that includes an upward direction heading the top surface from the bottom surface and a downward direction heading the bottom surface from the top surface. The X-axis direction, the Y-axis direction, and the Z-axis direction intersect one another. In the illustrated example, the X-axis direction, the Y-axis direction, and the Z-axis direction are perpendicular to one another.

### I. First Embodiment

FIG. 3 is a cross-sectional view of the pointing stick 9, according to a first embodiment. As illustrated in FIG. 3, the pointing stick 9 includes a sensor module 10 that detects pressure, the pole-like stick 20 fixed to the sensor module 10, and the cap 30 mounted on a distal end of the stick 20. The cap 30 is made of rubber material having a hardness A of 20 to 85 in a testing method for durometer hardness of plastics based on JIS K7215:1986 and is elastically deformed when being pressed with a finger.

The cap 30 has a first surface (bottom surface) 30B that faces the sensor module 10 and a second surface (top surface) 30A opposite to the first surface 30B. The second surface 30A is formed in a dome shape, for example, and is exposed from the keyboard 8 in a state in which the electronic device 1 is assembled as illustrated in FIG. 1. A bottomed hole 31 is provided in the first surface 30B. A distal end part including the distal end surface 22 and a part of a side surface 23 of the stick 20 is inserted in the bottomed hole 31.

The bottomed hole 31 is composed of a bottom wall 32 that faces the distal end surface 22 of the stick 20, and a side wall 33 that faces the side surface 23 of the stick 20. In the illustrated example, a bottom surface of the bottom wall 32 is formed in parallel with the first surface 30B. The side wall 33 connects the bottom wall 32 and the first surface 30B. An inner surface of the side wall 33 stands perpendicularly to the bottom surface of the bottom wall 32. The contact portion 34 that protrudes toward the first surface 30B is provided on the bottom wall 32.

In other words, the bottomed hole 31 that extends in the Z-axis direction is formed in the cap 30. The bottom surface of the bottom wall 32 is formed in parallel with the X-axis direction and the Y-axis direction. The inner surface of the side wall 33 is formed in parallel with the Z-axis direction. A distal end of the contact portion 34 is located closer to the first surface 30B than the bottom surface of the bottom wall 32. In a state in which the cap 30 is mounted on the stick 20, the contact portion 34 protrudes toward the distal end surface 22 and abuts on the distal end surface 22.

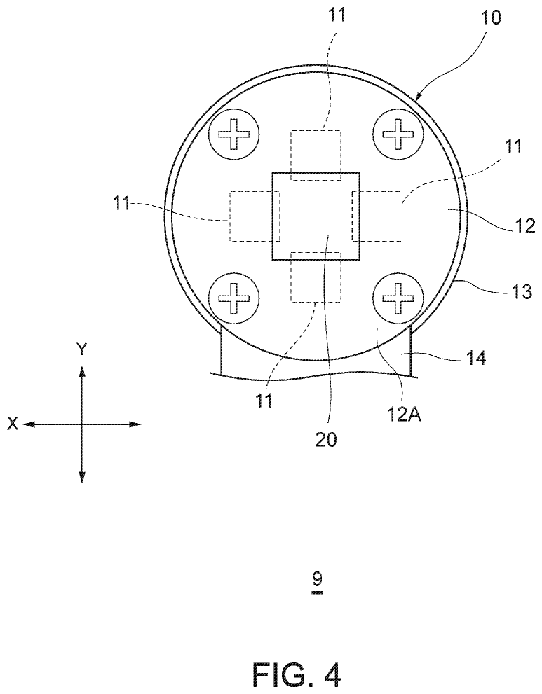

FIG. 4 is a top view of the pointing stick 9 with the cap 30 removed. The stick 20 is made of ceramic material and formed in a square pole shape, for example. It is to be noted that the stick 20 is not limited to the illustrated example. It may be made of resin and be in a columnar shape in appearance.

The sensor module 10 is configured as a strain gauge type in which when a load is applied, a flat plate-like plate 12 elastically deforms slightly and a resistance value of a strain sensor (strain gauge) 11 provided on the plate 12 changes, for example. In the illustrated example, the sensor module 10 includes the plate 12 that is formed in a flat plate shape, the strain sensor 11 provided on a bottom surface 12B (illustrated in FIG. 3) of the plate 12, and a bracket 13 that holds the plate 12. The plate 12 is preferably made from a glass epoxy substrate. However, the material of the plate 12 is not limited thereto and it may be made of ceramic or resin.

The bracket 13 is fixed to the above-mentioned keyboard substrate 81 by a fastening screw etc. A proximal end surface 21 (illustrated in FIG. 3) of the stick 20 is fixed to a top surface 12A of the plate 12 by an adhesive etc. The strain sensors 11 are provided by printing or pasting at four locations, front, rear, right, and left, viewed from the proximal end surface 21 of the stick 20, and detect a component Fx in the right and left direction of the pressing force F and a component Fy in the front and rear direction of the pressing force F.

The strain sensor 11 is electrically connected to the above-mentioned keyboard substrate 81 and chipset by a cable 14. The keyboard substrate 81 or chipset etc. is mounted with a resistance change sensor circuit that converts an amount of compression or an amount of tensile detected by the sensor module 10 to an analog signal, a signal comparison circuit that further converts the analog signal to a digital signal, an amplifier circuit, and an A/D converter circuit etc.

It is to be noted that the configuration of the sensor module 10 is not limited particularly, as long as a force F inputted from a user can be detected. It may be a piezoelectric type in which when a load is applied, a flat plate-like piezoelectric element generates a charge, and a voltage of an electrode foil sandwiched between piezoelectric elements changes, for example. In any case, the pointing stick 9 is configured that the pole-like stick 20 is fixed to the sensor module 10 formed in a flat plate shape and the components Fx and Fy that are parallel to the sensor module 10 are detected.

FIG. 5 is a bottom view of the cap 30. As illustrated in FIG. 5, the bottom wall 32 is formed in a substantially square shape to follow the cross section of the stick 20 illustrated in FIG. 4, for example. In the illustrated example, the bottom wall 32 is substantially formed in a several millimeter square shape. However, the shape of the bottom wall 32 is not limited to the illustrated example. When the cross section of the stick 20 is a circle, the bottom wall 32 may be formed in a circle having substantially the same diameter or formed in a shape of a substantial square that is circumscribed to the circle.

The contact portion 34 is provided in a region away from the outer edge 35 of the bottom wall 32, in the bottom wall 32. In the illustrated example, the contact portion 34 is provided in a region other than four corners of the bottom wall 32. More specifically, the single contact portion 34 is disposed in the central region 37 of the bottom wall 32. In the illustrated example, the contact portion 34 is formed like a square pole that extends while being equally spaced apart from the front, rear, right, and left side walls 33. Although not illustrated, the contact portion 34 may be in a columnar shape or may be in a substantial cross-shape in cross-section.

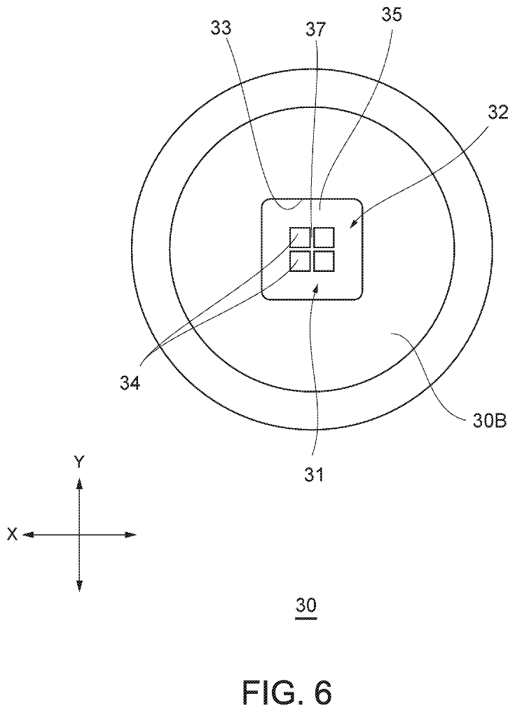

FIG. 6 is a bottom view illustrating another example of the cap 30 of the first embodiment. As illustrated in FIG. 6, the number of the contact portions 34 according to the first embodiment is not necessarily one. For example, multiple protruding portions may gather in the central region 37 to form the contact portions 34. From a different perspective, the contact portion 34 divided into multiple (for example, four) sections may be disposed in the central region 37 of the bottom wall 32. Each contact portion 34 is provided in a region away from the outer edge 35 of the bottom wall 32 and is disposed close to each other.

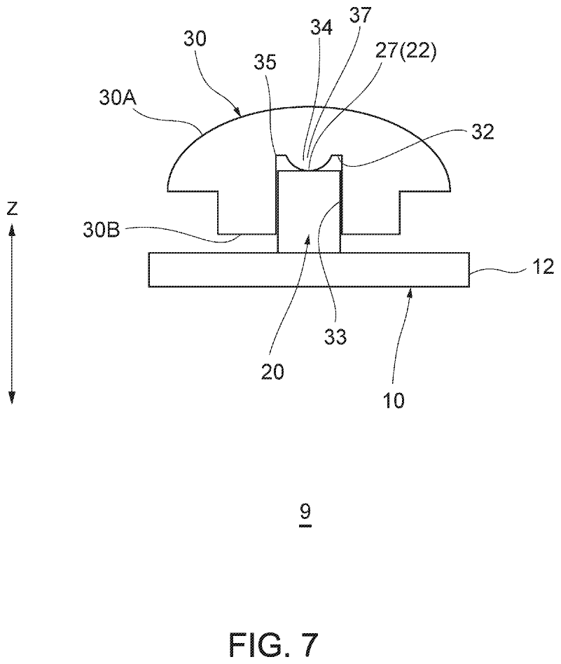

FIG. 7 is a cross-sectional view of the cap 30 according to a first embodiment. As illustrated in FIG. 7, the contact portion 34 may be in a tapered shape whose cross-sectional area decreases toward the bottom. In the illustrated example, the contact portion 34 is formed like a hemisphere that protrudes from the bottom wall 32. Although not illustrated, the contact portion 34 may be formed in a frustum of a pyramid or a frustum of a cone.

According to the cap 30 and the pointing stick 9 with the cap 30 of the first embodiment configured as above, since the contact portion 34 is provided in the region away from the outer edge 35 of the bottom wall 32, a force from a user is transmitted to near the central region 27 not to near the outer peripheries 26P and 26D of the distal end surface 22 of the stick 20, as illustrated in FIG. 3 and FIG. 9. Since a moment of a force that attempts to push the stick 20 down to the outer periphery 26P side decreases, a mouse pointer is easily operated as intended by a user even though the ratio of the component Fz in the perpendicular direction of the force F that presses the second surface 30A obliquely downward becomes higher.

In addition, according to the first embodiment, it can be expected to reduce a load on the display surface 3A more than before. If projection area of the contact portion 134 is large, the load on the display surface 3A tends to be heavy when the cap 100 comes into contact with the display surface 3A of the display 3. In comparison between the area obtained by projecting the single contact portion 34 illustrated in FIG. 5 toward the second surface 30A in the Z-axis direction and the area obtained by projecting the multiple contact portions 134 illustrated in FIG. 8 toward the second surface in the Z-axis direction, the former is configured to have smaller projection area due to the reduced number of the contact portions.

### II. Second Embodiment

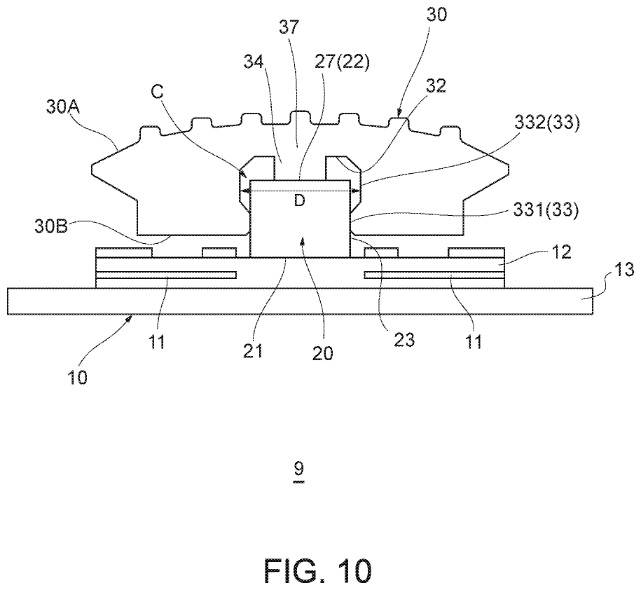

FIGS. 10-12 illustrate the cap 30 of the second embodiment. It is to be noted that constituent elements having the same functions as or similar functions to those of the first embodiment are denoted by the same symbols with reference to the descriptions of the first embodiment, and their explanations will be omitted. FIG. 10 is a cross-sectional view illustrating one example of the pointing stick 9 according to the second embodiment. As illustrated in FIG. 10, the cap 30 of the second embodiment is different from that of the first embodiment in that a gap C is formed between the side surface 23 of the stick 20 and the side wall 33 of the cap 30 in an outer edge of the distal end surface 22 of the stick 20 and the vicinity thereof.

Focusing on the bottomed hole 31, an opening of a first part 331 that is close to the first surface (bottom surface) 30B is more narrowed to be smaller than that of a second part 332 that is close to the second surface (top surface) 30A. In other words, in the direction parallel to the first surface 30B (for example, the X-axis direction or the Y-axis direction), an interval (inside dimension) D between the side walls 33 of the bottomed hole 31 in the second part 332 close to the second surface 30A is wider than that in the first part 331 close to the first surface 30B.

Thus, in a state in which the cap 30 is mounted on the stick 20, the side wall 33 of the bottomed hole 31 abuts on the side surface 23 of the stick 20 in the first part 331 on the first surface 30B side, while it is away from the side surface 23 of the stick 20 in the second part 332 on the second surface 30A side. In the illustrated example, the first part 331 protrudes inwardly more than the second part 332 to be formed like a square ring. The first part 331 may be continuous or discontinuous in the circumferential direction of the stick 20.

According to the second embodiment, a force from a user is transmitted to near the central region 27 not to near the outer peripheries 26P and 26D of the distal end surface 22, in the distal end surface 22 of the stick 20, similarly to the first embodiment. Since a moment of a force that attempts to push the stick 20 down to the outer periphery 26P side decreases, a mouse pointer is easily operated as intended by a user even though the ratio of the component Fz in the perpendicular direction of the force F that presses the second surface 30A obliquely downward becomes higher.

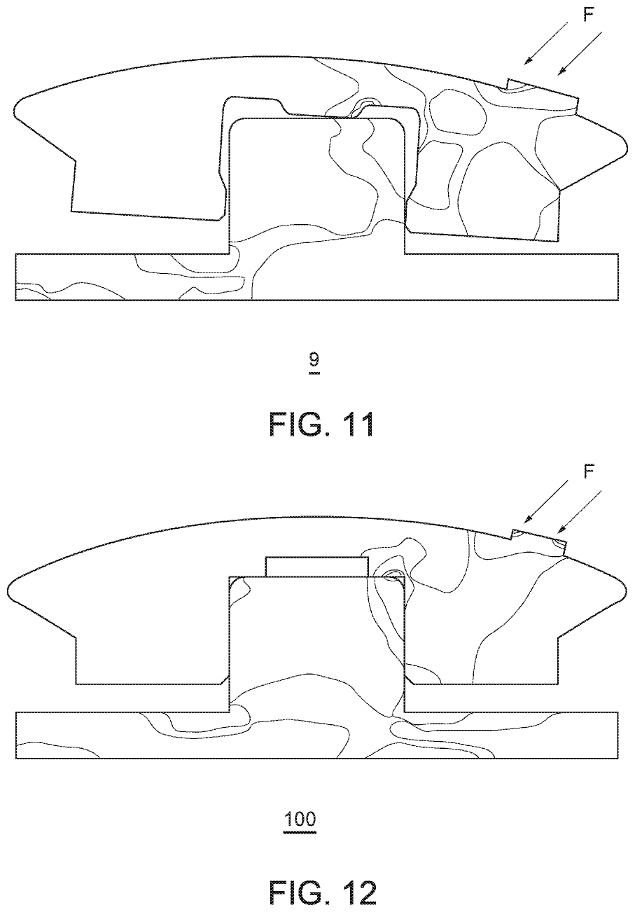

FIG. 11 is a cross-sectional view illustrating a stress distribution when the cap 30 illustrated in FIG. 10 is used, and FIG. 12 is a cross-sectional view illustrating a stress distribution when the conventional cap 100 is used. In the conventional configuration, a force from a user was transmitted to near the distal end surface 22 in the side surface 23 of the stick 20, as illustrated in FIG. 12.

In contrast, in the second embodiment, a force from a user is transmitted to near the proximal end surface 21 not to near the distal end surface 22 in the side surface 23 of the stick 20, as illustrated in FIG. 11. According to the second embodiment, since a moment of a force that acts on the side surface 23 of the stick 20 to attempt to push the stick 20 down in an undesired direction decreases, a mouse pointer is easily operated as intended by a user.

As has been described, the present invention provides an electronic device having an improved pointing stick.

While the invention has been particularly shown and described with reference to a preferred embodiment, it will be understood by those skilled in the art that various changes in form and detail may be made therein without departing from the spirit and scope of the invention.

What is claimed is:

1. A pointing stick, comprising:
a stick;
a cap having a first surface and a second surface opposite to said first surface; and
a bottomed hole recessed from said first surface towards said second surface is formed in said first surface, wherein said bottomed hole includes
a bottom wall located between said first surface and said second surface,
a side wall connecting said bottom wall and said first surface, and
a contact portion protruding from said bottom wall towards said first surface, wherein said contact portion is provided in a region away from an outer edge of said bottom wall.

2. The pointing stick of claim 1, wherein said bottom wall is substantially square-shaped.

3. The pointing stick of claim 1, wherein said contact portion is provided on a region other than four corners of said bottom wall.

4. The pointing stick of claim 1, wherein said contact portion is provided in a center of said bottom wall.

5. The pointing stick of claim 1, wherein said cap is made of a rubber material having a hardness A of 20 to 85.

6. The pointing stick of claim 1, wherein said contact portion is formed by gathering a plurality of protruding portions.

7. The pointing stick of claim 1, wherein an opening of a first part of said bottomed hole is smaller than that of a second part of said bottomed hole/

8. The pointing stick of claim 1, wherein said first part being close to said first surface and said second part being close to said second surface.

9. A pointing stick comprising:
a sensor module detects pressure;
a stick fixed to said sensor module;
a cap mounted on a distal end of said stick; and
a bottomed hole into a distal end part having a part of a side surface and a distal end surface of said stick is inserted, wherein said bottomed hole is formed in said cap, wherein said bottomed hole includes
a bottom wall facing said distal end surface,
a side wall facing a part of said side surface, wherein in a state in which said cap is mounted on said stick, and
a contact portion transmits a force inputted from a user pressing said stick is provided in a region away from an outer edge of said bottom wall.

10. The pointing stick of claim 9, wherein in a state in which said cap is mounted on said stick, said side wall of said bottomed hole abuts on said side surface of said stick close on said first surface side, while it is away from said side surface of said stick close on said second surface side.

11. An electronic device, comprising:
a display chassis and a keyboard chassis; and
a pointing stick in said keyboard chassis, wherein said pointing stick includes
a stick;
a cap having a first surface and a second surface opposite to said first surface; and
a bottomed hole recessed from said first surface towards said second surface is formed in said first surface, wherein said bottomed hole includes
a bottom wall located between said first surface and said second surface,
a side wall connecting said bottom wall and said first surface, and
a contact portion protruding from said bottom wall towards said first surface, wherein said contact portion is provided in a region away from an outer edge of said bottom wall.

12. The electronic device of claim 11, wherein said bottom wall is substantially square-shaped.

13. The electronic device of claim 11, wherein said contact portion is provided on a region other than four corners of said bottom wall.

14. The electronic device of claim 11, wherein said contact portion is provided in a center of said bottom wall.

15. The electronic device of claim 11, wherein said cap is made of a rubber material having a hardness A of 20 to 85.

16. The electronic device of claim 11, wherein said contact portion is formed by gathering a plurality of protruding portions.

17. The electronic device of claim 11, wherein an opening of a first part of said bottomed hole is smaller than that of a second part of said bottomed hole/

18. The electronic device of claim 11, wherein said first part being close to said first surface and said second part being close to said second surface.
